(19) United States
(12) Patent Application Publication
(10) Pub. No.: US 2012/0143543 A1
(43) Pub. Date: Jun. 7, 2012

(54) MEASURING DEVICE AND ELECTRONIC APPARATUS USING THE SAME

(75) Inventor: XING-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/222,369

(22) Filed: Aug. 31, 2011

(30) Foreign Application Priority Data
Dec. 6, 2010 (CN) 201010574553.X

(51) Int. Cl. G06F 19/00

(52) U.S. Cl. 702/63

(57) ABSTRACT

A measuring device includes a number of detectors and a processing unit. The detectors are used for detecting a supply voltage of a power source, and respectively generating a number of detecting signals. The processing unit is used for determining whether each of the detecting signals is at a first level or a second level, calculating a total number of the first level detecting signals, and acquiring a current power level of the power source according to the total number.

### BACKGROUND

1. Technical Field

The disclosed embodiments relate to measuring devices, and particularly relates to a measuring device for measuring the charge of a battery and an electronic apparatus.

2. Description of Related Art

Electronic apparatuses, such as mobile phones, notebook computers, etc., are capable of displaying the level of electrical charge (hereinafter “power level”) in the battery. A typical electronic apparatus includes a processing unit and a display unit. A plurality of reference voltage ranges are preset in the processing unit, and the reference voltage ranges respectively correspond to different power levels. The processing unit measures voltage of the battery, compares the measured voltage with the reference voltage ranges, and the corresponding power level of the battery is acquired. The display unit displays the power level of the battery.

However, the processing unit is a core component of the electronic apparatus, and needs to perform many functions. If the detecting operation of voltage of the battery and the comparison operation of the detected voltage with the reference voltage ranges are also performed by the processing unit, then the performance of other functions may be slowed or delayed.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout two views.

FIG. 1 is a block diagram of an electronic apparatus in accordance with one embodiment.

FIG. 2 is a circuit diagram of the electronic apparatus in FIG. 1.

### DETAILED DESCRIPTION

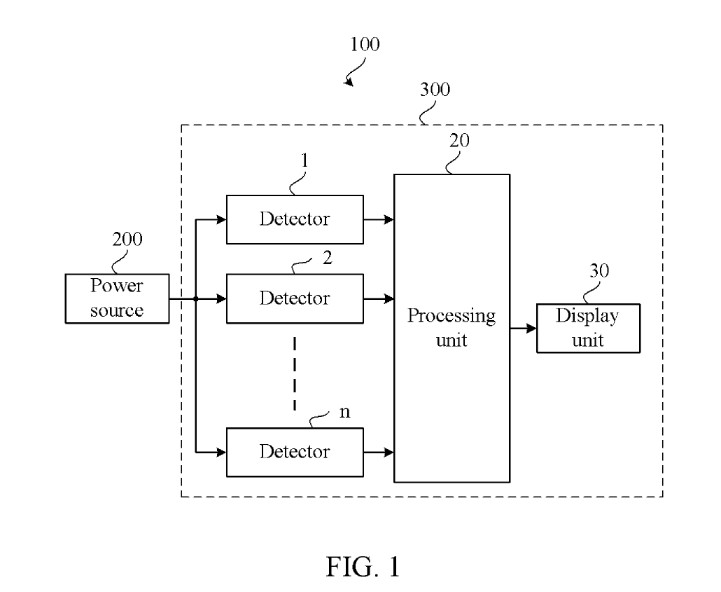

Referring to FIG. 1, an electronic apparatus 100 includes a power source 200 and a measuring device 300. The power source 200 is used for providing a supply voltage. The measuring device 300 is used to measure a voltage of the power source 200, to determine a current power level of the power source 200. In this embodiment, the power source 200 is a battery.

The measuring device 300 includes a plurality of detectors 1, 2 . . . , n, a processing unit 20, and a display unit 30. The detectors 1, 2 . . . , n are used for detecting the supply voltage of the power source 200, and respectively generating a plurality of detecting signals.

The processing unit 20 is used for determining whether each of the detecting signals is at a first level or a second level, calculating a total number of the first level detecting signals; and acquiring the current power level of the power source according to the total number. The total number of the first level detecting signals corresponds to the current power level of the power source 200. In this embodiment, the first level is a logic low level, the second level is a logic high level.

The display unit 30 displays the current power level of the power source 200. In this embodiment, a total number of the detectors is determined according to how many levels of power are to be detected of the power source 200. For example, if it is desired to be able to indicate power levels by fifth, such as 20%, 40%, 60%, 80%, 100%, then there are 5 power levels, and so there should be 5 detectors. Taking the power source 200 as the battery for example, if there are 5 logic low level signals, the current power level of the battery can be indicated as 5 or 100%, indicating the battery is full.

If there are no logic low level signals, the current power level of the battery can be indicated as 0 or 0%, indicating the battery must be charged. Therefore, users can know the current charge of the battery in real time.

Because the detecting operation of voltage of the power source 200 is performed by the detectors 1, 2 . . . , n, and not by the processing unit 20, the performance of other functions of the processing unit 20 may be enhanced.

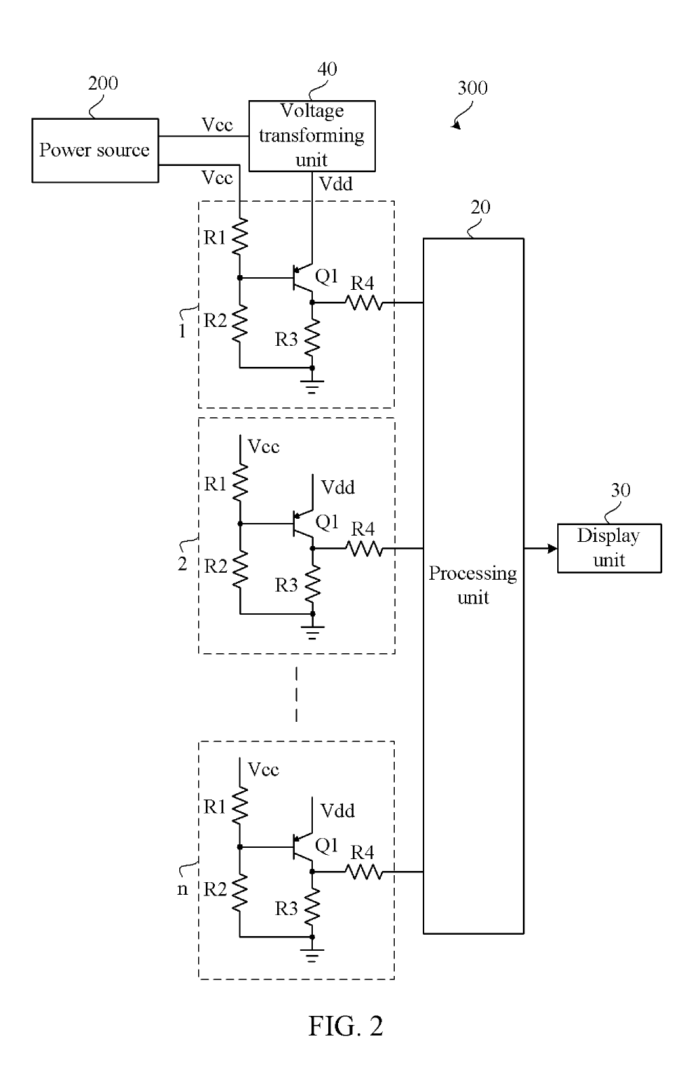

Referring to FIG. 2, the measuring device 300 further includes a voltage transforming unit 40. The voltage transforming unit 40 is used for transforming the supply voltage Vcc of the power source 200 to an invariable voltage Vdd. Each of the detectors 1, 2 . . . , n includes a first resistor R1, a second resistor R2, a third resistor R3, a fourth resistor R4, and a transistor Q1. One end of the first resistor R1 receives the supply voltage Vcc from the power source 200, and the other end of the first resistor R1 is grounded through the second resistor R2. A base of the transistor Q1 is connected between the first resistor R1 and the second resistor R2, a collector of the transistor Q1 is grounded through the third resistor R3, the collector of the transistor Q1 is further connected to the processing unit 20 through the fourth resistor R4, an emitter of the transistor Q1 receives the invariable voltage Vdd from the voltage transforming unit 40. In this embodiment, the transistor is a pnp type transistor.

All the detectors are the same except that the resistance of the resistors R1 and R2 are different as explained below.

Taking power level of the battery being three as an example, there are three detectors, that is, a first detector, a second detector, and a third detector. The first level is a logic low level (0), the second level is a logic high level (1). The relationship of the total number of logic low level detecting signals generated by the three detectors and the current power level of the power source 200 is as follows.

| | first | second | third | current |
|---|---|---|---|---|
| | detector | detector | detector | power level |
| logic low level or | 0 | 0 | 0 | 3 |
| logic high level | 1 | 0 | 0 | 2 |
| | 1 | 1 | 0 | 1 |
| | 1 | 1 | 1 | 0 |

As shown above, if there are 3 logic low level signals, the current power level of the battery is 3 or 100%. If there are 2 logic low level signals, the current power level of the battery is 2 or 66%. If there are 1 logic low level signals, the current power level of the battery is 1 or 33%. If there are 0 logic low level signals, the current power level of the battery is 0 or 0%, and users can judge when to charge the battery accordingly.

The first resistor R1 and the second resistor R2 are used for dividing the supply voltage Vcc of the power source 200 to generate a bias voltage V1, and the bias voltage V1 is applied to the base of corresponding transistor Q1. In the example above, using three detectors, the resistance of resistors R1 and R2 must be selected to meet the following four requirements. Firstly, as described above, when the current power level is 3, in each of three detectors, the bias voltage V1 generated by the resistors R1 and R2 turns off the transistor Q1, thus the detecting signals respectively generated by three detectors are at the logic low level (0). Secondly, when the current power level is 2, in the first detector, the bias voltage V1 turns on the transistor Q1, thus the detecting signal generated by the first detector is at the logic high level (1). And in each of the second detector and the third detector, the bias voltage V1 turns off the transistor Q1, thus the detecting signals respectively generated by the second and third detectors are at the logic low level (0).

Thirdly, when the current power level is 1, in each of the first detector and the second detector, the bias voltage V1 turns on the transistor Q1, thus the detecting signals respectively generated by the first and second detectors are at the logic high level (1). And in the third detector, the bias voltage V1 turn off the transistor Q1, thus the detecting signal generated by the third detector is at the logic low level (0).

Fourthly, the supply voltage Vcc of the battery never goes to 0 volts because the electronic device will be shut down before the battery is fully discharged, thus, in the embodiment, when the current power level of the battery is considered as 0, the supply voltage Vcc of the battery is not 0 volts, it will be higher than 0 volts. Because the voltage transforming unit 40 transforms the supply voltage Vcc of the battery to an invariable voltage Vdd, when the supply voltage Vcc varies, the voltage Vdd is invaried. The first resistor R1 and the second resistor R2 divides the supply voltage Vcc to generate the bias voltage V1, so when the current power level of the battery is 0, the voltage Vdd can be larger than the supply voltage Vcc, thus the voltage Vdd is larger than the bias voltage V1, and the bias voltage V1 turns on the transistor Q1. Further, because the battery is a rechargeable battery, when the current power level of the battery is 0, the supply voltage of the battery is not 0 volts, it is larger than 0 volts. That is, when the current power level of the battery is 0, in each of three detectors, the bias voltage V1 turns on the transistor Q1, thus the detecting signals respectively generated by three detectors are at the logic high level (1). In this way, the battery charge is determined in real time according to the number of low level signals generated, without using the limited resources of the processing unit 20.

Alternative embodiments will be apparent to those skilled in the art without departing from the spirit and scope of what is claimed. Accordingly, the present invention should be deemed not to be limited to the above detailed description, but rather only by the claims that follow and equivalents thereof.

What is claimed is:

1. A measuring device, comprising:
a plurality of detectors for detecting a supply voltage of a power source, and respectively generating a plurality of detecting signals;
a processing unit for determining whether each of the detecting signals is at a first level or a second level, calculating a total number of the first level detecting signals; and acquiring a current power level of the power source according to the total number.

2. The measuring device of claim 1, wherein a total number of detectors is determined according to how many levels of power are to be detected of the power source.

3. The measuring device of claim 1, wherein the total number of the first level detecting signals corresponds to the current power level of the power source.

4. The measuring device of claim 1, wherein the first level is a logic low level, the second level is a logic high level.

5. The measuring device of claim 1, further comprising a display unit for displaying the current power level of the power source.

6. The measuring device of claim 1, further comprising a voltage transforming unit for transforming the supply voltage to an invariable voltage, wherein each of the detectors comprises a first resistor, a second resistor, a third resistor, and a transistor, one end of the first resistor receives the supply voltage, the other end of the first resistor is grounded through the second resistor, a base of the transistor is connected between the first resistor and the second resistor, a collector of the transistor is grounded through the third resistor and is further connected to the processing unit, an emitter of the transistor receives the invariable voltage.

7. The measuring device of claim 6, wherein all the detectors are the same except that the resistance of the first resistor and the second resistor are different, the transistor is a pnp type transistor.

8. The measuring device of claim 6, wherein there are three detectors, that is, a first detector, a second detector, and a third detector, the first level is a logic low level (0), the second level is a logic high level (1), the relationship of the total number of first level detecting signals generated by the three detectors and the current power level of the power source is as follows:

| | first | second | third | current |
|---|---|---|---|---|
| | detector | detector | detector | power level |
| logic low level (0)/ | 0 | 0 | 0 | 3 |
| logic high level (1) | 1 | 0 | 0 | 2 |
| | 1 | 1 | 0 | 1 |
| | 1 | 1 | 1 | 0 |

9. The measuring device of claim 8, wherein the first resistor and the second resistor are used to divide the supply voltage to generate a bias voltage applied to the base of corresponding transistor, the resistance of first resistor and second resistor must be selected to meet the following four requirements: firstly, when the current power level is 3, in each of three detectors, the bias voltage turns off the transistor; secondly, when the current power level is 2, in the first detector, the bias voltage turns on the transistor; in each of second detector and third detector, the bias voltage turns off the transistor; thirdly, when the current power level is 1, in each of first detector and second detector, the bias voltage turns on the transistor; in the third detector, the bias voltage turn off the transistor; fourthly, when the current power level of the battery is 0, in each of three detectors, the bias voltage turns on the transistor.

10. An electronic apparatus, comprising:
a power source for providing a supply voltage;
a plurality of detectors connected to the power source for detecting the supply voltage, and respectively generating a plurality of detecting signals;
a processing unit for determining whether each of the detecting signals is at a first level or a second level, calculating a total number of the first level detecting signals; and
acquiring a current power level of the power source according to the total number.

11. The electronic apparatus of claim 10, wherein a total number of detectors is determined according to how many levels of power are to be detected of the power source.

12. The electronic apparatus of claim 10, wherein the total number of the first level detecting signals corresponds to the current power level of the power source.

13. The electronic apparatus of claim 10, wherein the first level is a logic low level, the second level is a logic high level.

14. The electronic apparatus of claim 10, further comprising a display unit for displaying the current power level of the power source.

15. The electronic apparatus of claim 10, further comprising a voltage transforming unit for transforming the supply voltage to an invariable voltage, wherein each of the detectors comprises a first resistor, a second resistor, a third resistor, and a transistor, one end of the first resistor receives the supply voltage, the other end of the first resistor is grounded through the second resistor, a base of the transistor is connected between the first resistor and the second resistor, a collector of the transistor is grounded through the third resistor and is further connected to the processing unit, an emitter of the transistor receives the invariable voltage.

16. The electronic apparatus of claim 15, wherein all the detectors are the same except that the resistance of the first resistor and the second resistor are different, the transistor is a pnp type transistor.

17. The electronic apparatus of claim 15, wherein the detector comprises a fourth resistor, one end of the fourth resistor is connected to the collector of the transistor, the other end other of the fourth resistor is connected to the processing unit, a resistance of the fourth resistor of each of the detectors is the same.

18. A measuring device, comprising:
a plurality of detectors for detecting a supply voltage of a battery, and respectively generating a plurality of detecting signals, each of the detecting signals being different;
a processing unit for determining whether each of the detecting signals is at a first level or a second level, calculating a total number of the first level detecting signals; and acquiring a current power level of the battery according to the total number.
